(19) United States
(12) Patent Application Publication
(10) Pub. No.: US 2016/0026380 A1
(43) Pub. Date: Jan. 28, 2016

(54) HAND-HELD ELECTRONIC DEVICE, COMPUTER-EXECUTED METHOD AND TOUCH-SENSING COVER

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/725,360

(22) Filed: May 29, 2015

(30) Foreign Application Priority Data
Jul. 25, 2014 (CN) 201410361579.4

(51) Int. Cl. G06F 3/0488; G06F 3/0484; G06F 3/044; G06F 3/047; G09G 5/00

(52) U.S. Cl. CPC G06F 3/04883; G06F 3/047; G09G 5/003; G06F 3/044; G06F 3/0484; G09G 2300/0426

(57) ABSTRACT

A hand-held electronic device comprises a touch-sensing cover, a panel and a control unit. The touch-sensing cover comprises a cover and a touch-sensing structure. Partial or total area of the touch-sensing structure is disposed on the cover and the touch-sensing structure comprises a plurality of detection points. The control unit is electrically connected with the touch-sensing cover and the panel and executes following steps of: computing a trigger event of the detection points; comparing the trigger event with an initiative determination condition pre-stored in the hand-held electronic device; permitting the touch-sensing structure to receive at least one input action inputted by a user if the trigger event conforms to the initiative determination condition; and executing an opening or closing of the hand-held electronic device by the input action. Therefore, the finger can be prevented from shading user's view.

### CROSS REFERENCE TO RELATED APPLICATIONS

This Non-provisional application claims priority under 35 U.S.C. §119(a) on Patent Application No(s). 201410361579.4 filed in People's Republic of China on Jul. 25, 2014, the entire contents of which are hereby incorporated by reference.

### BACKGROUND OF THE INVENTION

1. Field of Invention

This invention relates to a hand-held electronic device, a touch-sensing cover and a computer-executed method and, in particular, to a hand-held electronic device, a touch-sensing cover and a computer-executed method whereby the hand-held electronic device can be turned on or off

2. Related Art

With the progress of technologies, various novel information devices are invented, such as cell phones, tablet computers, ultrabooks and GPS (Global Positioning System) navigation devices. Generally, a keyboard and mouse are commonly used to manipulate a digital device for inputting information. Additionally, the touch control technology currently also becomes a popular manipulation method for a digital device and brings an intuitive operation. Accordingly, a touch display device using the touch control technology can provide a user friendly and intuitive interface for the input operation, and therefore users of all ages can manipulate the touch display device by fingers or a stylus.

In a common and conventional hand-held electronic device with the touch function, the touch operations are all directly executed on the panel. However, because users have to do operation on the panel, their fingers may shade their view or the functional item displayed by the panel, so that the user may erroneously touch, by the finger, an undesired item which is displayed in a high information density image. In order to avoid the above situation, some hand-held electronic devices adopt a design which separates the touch operation area from the display panel, such as disclosed by the U.S. Pat. No. 5,825,352 (Logitech).

However, such design will increase the volume of the electronic device and go against the tendency of the hand-held electronic device towards lightness, thinness and compactness, so as not to be easily carried out in the small-sized product such as tablet computer and cell phone. Moreover, the technique disclosed by the U.S. Pat. No. 5,825,352 (Logitech) also can't solve problem of that user's view is easily shaded by user's finger in the operation on the hand-held electronic device.

Furthermore, the above-mentioned panel also needs to be configured with the rare earth transparent touch-sensing structure such as ITO (indium tin oxide) so as to be kept in the touch and display functions, but since the rare earth metal of indium is unceasingly consumed, the cost of the product is getting higher and higher. Besides, the conductivity of the rare earth metal is worse than the normal metal. Therefore, using the transparent touch-sensing layer made by the rare earth metal of indium is not a good choice. In addition, when the user uses the hand-held electronic device under the strong sunlight, the sunlight readability of the panel is always a problem that can't be effectively solved. Since the user can't see the information displayed on the panel, the information such as email or Facebook can't be respond promptly by the two-hand operation of the user.

Besides, the frequent touch operation by user's finger or stylus on the touch panel of the hand-held electronic device will scratch the panel. Moreover, in the common use of the hand-held electronic device with the touch function, one hand is used to hold the electronic device while the other hand is used to execute the touch operation on the panel. So, when the user just uses one hand to hold and operate the device at the same time, the touch operation only can be executed by the thumb, and thus the efficiency, accuracy and convenience of manual operation are reduced.

Therefore, it is important to provide a hand-held electronic device, a touch-sensing cover and a computer-executed method whereby the user's view can be prevented from being shaded by the finger during the operation and the panel scratch problem can be reduced, moreover, the convenience of the single-hand operation can be enhanced.

### SUMMARY OF THE INVENTION

An aspect of the invention is to provide a hand-held electronic device, a touch-sensing cover and a computer-executed method whereby the user's view can be prevented from being shaded by the finger during operating on the panel and the scratch problem can be reduced, furthermore, the convenience of the single-hand operation can be enhanced.

Therefore, a hand-held electronic device of this invention comprises a touch-sensing cover, a panel and a control unit. The touch-sensing cover comprises a cover and a touch-sensing structure. Partial or total area of the touch-sensing structure is disposed on the cover and the touch-sensing structure comprises a plurality of detection points. The control unit is electrically connected with the touch-sensing cover and the panel, and executes following steps of: computing a trigger event of the detection points; comparing the trigger event with an initiative determination condition pre-stored in the hand-held electronic device; permitting the touch-sensing structure to receive at least an input action inputted by a user if the trigger event conforms to the initiative determination condition; and executing an opening or closing of the hand-held electronic device by the input action.

In one embodiment, when the hand-held electronic device is in a conversation state, the closing to end the conversation is executed by the input action if the input action is a simultaneous contact or a pinch slide of two fingers on the touch-sensing cover.

In one embodiment, when the hand-held electronic device is in a non-conversation state and opening an application program, the closing to close the application program is executed by the input action if the input action is a simultaneous contact or a pinch slide of two fingers on the touch-sensing cover.

In one embodiment, when the hand-held electronic device is in a non-conversation state and no application program opened, the closing to turn off the hand-held electronic device is executed by the input action if the input action is a simultaneous contact or a pinch slide of two fingers on the touch-sensing cover.

In one embodiment, when the hand-held electronic device is in a non-conversation state and no application program opened, the opening to open an application program of the hand-held electronic device is executed by the input action if the input action is a simultaneous contact or a stretch slide of two fingers on the touch-sensing cover.

In one embodiment, when the hand-held electronic device is in a shutdown state, the opening to turn on the hand-held electronic device is executed by the input action if the input action is a simultaneous contact or a stretch slide of two fingers on the touch-sensing cover.

In one embodiment, the touch-sensing structure is a single-layer structure or a double-layer structure.

In one embodiment, a wiring connecting to the touch-sensing structure is gathered to a single side for wiring outlet.

In one embodiment, a width of the touch-sensing structure is less than that of the cover by 5%˜10%.

In one embodiment, the area of the touch-sensing structure has a ratio relationship to the area of the panel, and the control unit converts an input position of the touch-sensing structure to a display position of the panel according to the ratio relationship.

In one embodiment, the user operates the hand-held electronic device by one hand, and the touch-sensing cover faces a light source or the back of the panel faces the light source.

In one embodiment, the touch-sensing structure is capable of a wireless power transmission.

In one embodiment, the touch-sensing cover further comprises a near field communication unit, which comprises a near field communication chip and an antenna, the near field communication chip is electrically connected with the control unit, and the antenna is disposed on the cover or the touch-sensing structure.

Moreover, a computer-executed method of the invention is applied to a hand-held electronic device. The hand-held electronic device comprises a touch-sensing cover, a panel and a control unit. The method executes, on the hand-held electronic device, following steps of: computing a trigger event of a plurality of detection points on the touch-sensing cover; comparing the trigger event with an initiative determination condition pre-stored in the hand-held electronic device; permitting the touch-sensing cover to receive at least one input action inputted by a user if the trigger event conforms to the initiative determination condition; and executing an opening or closing of the hand-held electronic device by the input action.

In one embodiment, when the hand-held electronic device is in a conversation state, the closing to end the conversation is executed by the input action if the input action is a simultaneous contact or a pinch slide of two fingers on the touch-sensing cover.

In one embodiment, when the hand-held electronic device is in a non-conversation state and opening an application program, the closing to close the application program is executed by the input action if the input action is a simultaneous contact or a pinch slide of two fingers on the touch-sensing cover.

In one embodiment, when the hand-held electronic device is in a non-conversation state and no application program opened, the closing to turn off the hand-held electronic device is executed by the input action if the input action is a simultaneous contact or a pinch slide of two fingers on the touch-sensing cover.

In one embodiment, when the hand-held electronic device is in a non-conversation state and no application program opened, the opening to open an application program of the hand-held electronic device is executed by the input action if the input action is a simultaneous contact or a stretch slide of two fingers on the touch-sensing cover.

In one embodiment, when the hand-held electronic device is in a shutdown state, the opening to turn on the hand-held electronic device is executed by the input action if the input action is a simultaneous contact or a stretch slide of two fingers on the touch-sensing cover.

Furthermore, a touch-sensing cover of a hand-held electronic device of the invention is disclosed. The hand-held electronic device comprises the touch-sensing cover, a panel and a control unit. The touch-sensing cover comprises a cover and a touch-sensing structure. Partial or total area of the touch-sensing structure is disposed on the cover and the touch-sensing structure comprises a plurality of detection points. The control unit computes a trigger event of the detection points and compares the trigger event with an initiative determination condition pre-stored in the hand-held electronic device. If the trigger event conforms to the initiative determination condition, the touch-sensing structure is permitted to receive at least one input action inputted by a user, and an opening or closing of the hand-held electronic device is executed by the input action.

As mentioned above, in the hand-held electronic device, touch-sensing cover and computer-executed method of the invention, the user can execute the touch operation on the touch-sensing cover of the hand-held electronic device, so the user's finger will not shade the user's view or the software object displayed by the panel, additionally, the touch for opening the link in the high information density image won't be erroneously executed. Since the user operates the electronic device through the touch-sensing cover, thus, the panel scratch situation can be reduced. Because the user can execute the touch operation on the touch-sensing cover, the user can use multiple fingers such as the forefinger and middle finger to operate the electronic device while using the same hand holding the device. In comparison with the conventional art where the user just can use the thumb to execute the operation while holding the device with the same hand, this invention can provide more efficiency and convenience for the operation and can achieve a better user experience.

Furthermore, when the user uses the hand-held electronic device under the strong sunlight, the user can hold the hand-held electronic device by one hand and also use the touch-sensing cover to block the sunlight or a light source. Since the content displayed on the panel is shielded from the sunlight by the touch-sensing cover, the sunlight readability of the display panel can be enhanced, which is achieved without adopting the novel OLED (Organic Light-Emitting Diode) or electronic paper display panel technology.

In addition, on the premise that the trigger quantity distribution, trigger time, trigger frequency, trigger morphology (which can refer to trigger appearance) or trigger location (which can refer to trigger position) conforms to the initiative determination condition, the touch-sensing cover just can be permitted to receive at least one input action inputted by the user for executing the opening or closing of the hand-held electronic device, such as turning on or off the device, starting or ending the application program, or ending the conversation. Therefore, when other users want to operate the hand-held electronic device, the operation of the above-mentioned opening or closing will be forbidden because the trigger quantity distribution, trigger time, trigger frequency, trigger morphology or trigger location doesn't conform to the initiative determination condition set by the original user, and therefore the security of the hand-held electronic device can be enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a hand-held electronic device of an embodiment of the invention;

FIG. 2 is a function block diagram of the hand-held electronic device in FIG. 1;

FIG. 3 is a schematic diagram of the hand-held electronic device of FIG. 1 in another viewing angle;

FIG. 4 is a schematic flowchart of the computer-executed method of an embodiment of the invention;

FIG. 5 is a schematic diagram showing that the detection point of the touch-sensing cover in FIG. 1 is triggered;

FIGS. 6A and 6B are other schematic diagrams showing that the detection point of the touch-sensing cover of FIG. 1 is triggered;

FIGS. 7A and 7B are schematic diagrams showing that the user operates the hand-held electronic device of FIG. 1 according to an embodiment of the invention; and

FIGS. 8A to 8C are schematic diagrams showing that the user operates the hand-held electronic device of FIG. 1 according to other embodiments of the invention.

### DETAILED DESCRIPTION OF THE INVENTION

The present invention will be apparent from the following detailed description, which proceeds with reference to the accompanying drawings, wherein the same references relate to the same elements.

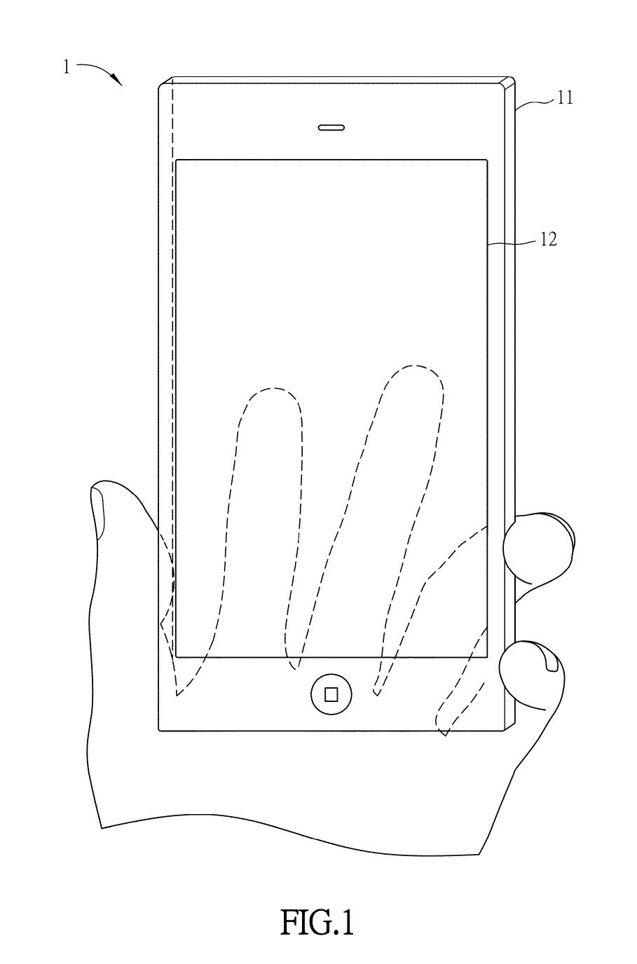

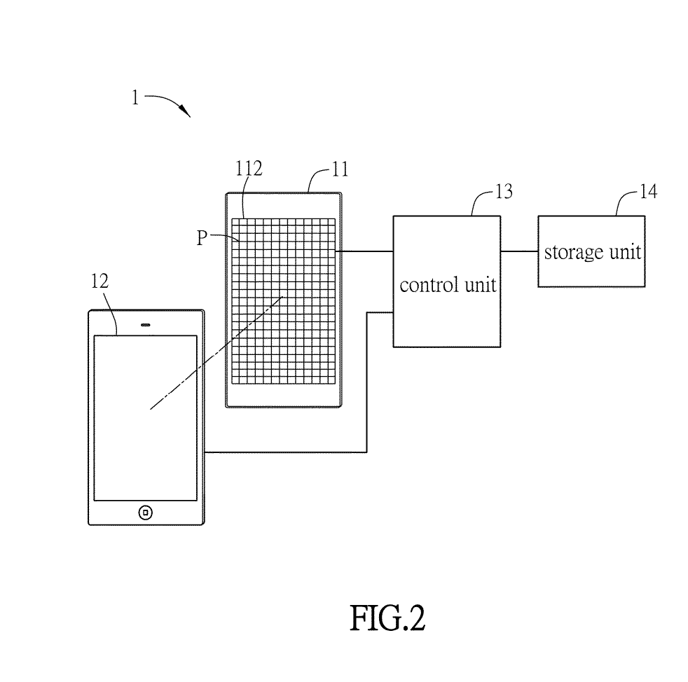

FIG. 1 is a schematic diagram of a hand-held electronic device of an embodiment of the invention, and FIG. 2 is a function block diagram of the hand-held electronic device in FIG. 1. As shown in FIGS. 1 and 2, the hand-held electronic device 1 of this embodiment includes a touch-sensing cover 11, a panel 12 and a control unit 13. The hand-held electronic device 1 of this embodiment can be a smart phone, a tablet or a personal digital assistant (PDA), and herein the smart phone is illustrated as an example. The panel 12 can include a display panel, i.e. a panel with the display function, or a touch display panel having both of the display and touch functions.

In this embodiment, the touch-sensing cover 11 is disposed on the side of the hand-held electronic device 1 against the panel 12. In other words, the touch-sensing cover 11 and the panel 12 are disposed on the opposite sides of the hand-held electronic device 1, i.e. the rear side and the front side of the hand-held electronic device 1, respectively. Accordingly, when the user normally uses the hand-held electronic device 1, the side facing the user is the front side and the side against the user is the rear side. The touch-sensing cover 11 and the panel 12 are coupled with the control unit 13 so that the control unit 13 can receive the user's input action through the touch-sensing cover 11 and control the content displayed on the panel 12.

In physical, the touch-sensing cover 11 of this embodiment provides an input interface which is used between the electronic device and the user. The panel 12 can display a user interface or a graphical user interface (GUI) for example. Therefore, as shown in FIG. 1, the user can see the content displayed by the panel 12 through the front side of the hand-held electronic device 1 and execute the input operation through the touch-sensing cover 11 on the rear side.

When the user uses the hand-held electronic device 1 under the strong sunlight or a strong light source, the user can operate the hand-held electronic device 1 by one hand and also adopt the touch-sensing cover 11 to face the strong sunlight or light source to block the sunlight or the light source. Because the panel 12 is against the sunlight or the light source, the touch-sensing cover 11 can block the sunlight or the light source and the sunlight readability of the panel 12 can be thus enhanced.

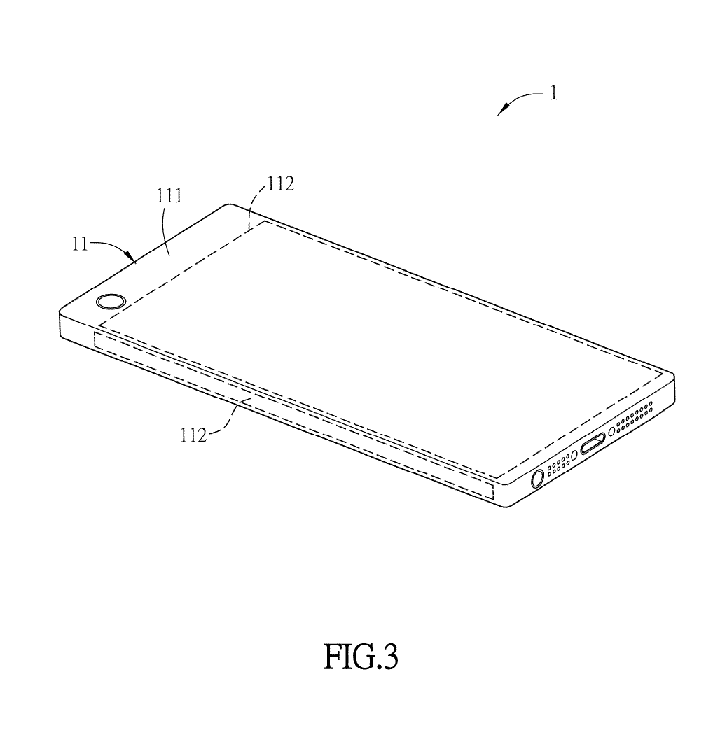

FIG. 3 is a schematic diagram of the hand-held electronic device of FIG. 1 in another viewing angle. As shown in FIGS. 2 and 3, in this embodiment, the touch-sensing cover 11 comprises a cover 111 and a touch-sensing structure 112. Likewise, the cover 111 is disposed on the side of the hand-held electronic device 1 opposite the panel 12. Partial or total area of the touch-sensing structure 112 can be disposed on the cover 111. In this embodiment, the touch-sensing structure 112 extends to the two sides of the cover 111, i.e. the two sides of the touch-sensing cover 11, so as to increase the area of the user's operation. In this case, the area of the touch-sensing structure 112 is larger than that of the panel 12. In other embodiments, another physical key can be replaced by the touch-sensing structure 112 of this embodiment.

In other embodiments, for more effectively using the width of the cover 111 to dispose the touch-sensing structure 112, the width of the touch-sensing structure 112 can be slightly less than that of the cover 111 (such as by 5%˜10%). That is, the width of the touch-sensing structure 112 is about 90%˜95% that of the cover 111. The touch-sensing structure 112 may also yield to the position of the camera lens or flash of the cover 111, so the touch-sensing structure 112 is not disposed at a local region of the cover 111 (namely the location where the camera lens or the flash are disposed). In other embodiments, the area of the touch-sensing structure 112 can be equal to that of the panel 12.

In this embodiment, the touch-sensing structure 112 is a capacitive touch structure for example and formed on the inner surface of the cover 111 facing the panel 12, and that means the touch-sensing structure 112 is disposed on the inside of the hand-held electronic device 1 and directly formed on the cover 111. In other embodiments, the touch-sensing structure 112 can be formed on the outer surface of the cover 111 opposite the panel 12, and that means the touch-sensing structure 112 is disposed on the outside of the hand-held electronic device 1. If the touch-sensing structure 112 is disposed on the outer surface of the cover 111 which is farther from the panel 12, a protection layer is required for protecting the touch-sensing structure 112. To be noted, the material of the cover 111 can be glass, plastic material, metal or other materials, and the cover 111 is a part of the whole structure of the hand-held electronic device 1. In other words, the touch-sensing cover 11 is not an additional component (the additional component is the protection cover of the electronic device for example), so if the touch-sensing cover 11 is separated from the hand-held electronic device 1, the inside components of the hand-held electronic device 1, such as battery or integrated circuit, can be seen.

Moreover, the touch-sensing structure 112 can be a single-layer or double-layer structure, and can be capable of wireless power transmission.

In this embodiment, the touch-sensing structure 112 is illustrated as a double-layer structure for example. The touch-sensing structure 112 can comprise a first sensing layer and a second sensing layer. The first sensing layer comprises a plurality of first sensing lines which are disposed along the first direction (X direction). The second sensing layer comprises a plurality of second sensing lines which are disposed along the second direction (Y direction).

In other embodiments, the touch-sensing structure may be a single-layer electrode structure. For example, the touch-sensing structure may comprise a plurality of sensing pads which are formed simultaneously, and the sensing pads may be in the form of a single-layer structure. The sensing pads may be a transparent conducting layer or a metal mesh. The shape of the sensing pad includes, but not limited to, a diamond shape or triangle, as long as they can help to achieve touch-sensing operations. Moreover, all sensing pads are unnecessary to have an identical shape.

The touch-sensing structure 112 can further include a transmitter circuit and a receiver circuit (i.e. the so-called Tx and Rx, not shown), and the material thereof can comprise metal mesh, metal nanowires, transparent conducting film, carbon nanotube or graphene, but this invention is not limited thereto. If the touch-sensing structure 112 is metal mesh, the Moire phenomenon can be reduced and also the material cost can be lowered down, and the wire width thereof will not be limited by the transparency requirement.

If the touch-sensing structure 112 is made by metal mesh, the metal texture effect can be exhibited on the appearance when the touch-sensing structure 112 is disposed on the outer surface (not the display surface) of the cover 111. Accordingly, because the metal texture effect can be achieved just by disposing the touch-sensing structure 112 composed of the metal mesh on the outer surface (not the display surface) of the cover 111 made by non-metal material, the metal-made cover (requiring a more complicated process) is not necessary to be adopted and cost down can be achieved.

In this embodiment, the area of the touch-sensing structure 112 has a ratio relationship to the area of the panel 12, and the control unit 13 can convert the touch points of the touch-sensing cover 11 to the corresponding positions of the panel 12 according to the ratio relationship. While the user operates the touch operation on the touch-sensing cover 11 by the finger for example, the panel 12 can display the corresponding operation according to the user's operation gesture (or called the hand gesture), wherein the control unit 13 will convert the input position of the touch-sensing structure 112 into the display position of the panel 12, and the panel 12 will display a visible object (such as a prompt) on the display position so that the user can interact with the graphical user interface displayed on the panel 12.

In addition, a circuit board, a battery or a memory card can be disposed between the touch-sensing cover 11 and the panel 12.

The wiring connecting to the touch-sensing structure 112 can be gathered to a single side for the wiring outlet and then electrically connected with a circuit board, so as to enhance the flexibility of the circuit design.

As shown in FIG. 2, the touch-sensing structure 112 comprises a plurality of detection points P, which can be triggered to by a trigger event. For example, when a user touches (such as adopting a stylus, finger or palm) the touch-sensing structure 112, the detection point P at the touch position can be triggered to generate the signal of the trigger event, and the signal will be transmitted to the control unit 13 for the judgment or analysis of the control unit 13 to the trigger event. Accordingly, the trigger event can be generated by corresponding to the holding position of the user when the user holds the touch-sensing cover 11, or can be generated when the user executes the input operation through the touch-sensing cover 11.

Because the touch-sensing cover 11 and the panel 12 are disposed on the opposite sides of the hand-held electronic device 1 respectively, so that the user's finger can be prevented from shading the image displayed by the panel 12 when the user operates the hand-held electronic device 1. Thereby, the purpose of the shadeless touch can be achieved and the erroneous touch can be further avoided.

As shown in FIG. 2, the hand-held electronic device 1 of this embodiment further comprises a storage unit 14, which is, for example but not limited to, ROM (read-only memory), RAM (random access memory), flash, field-programmable gate array (FPGA) or other kinds of memories. Herein for example, the storage unit 14 is illustrated as the RAM and coupled with the control unit 13 by a signal bus.

In this embodiment, the storage unit 14 stores the operation system, application programs, data processing programs and electronic data of various formats. The operation system is the program managing the computer hardware and software resources. The application program can be a word processing program, email program or others. The data processing program can be used to detect the data structure of the above-mentioned electronic data and generate the corresponding connection instruction. In this embodiment, the control unit 13 comprises a central processing unit (CPU) for example to execute the programs.

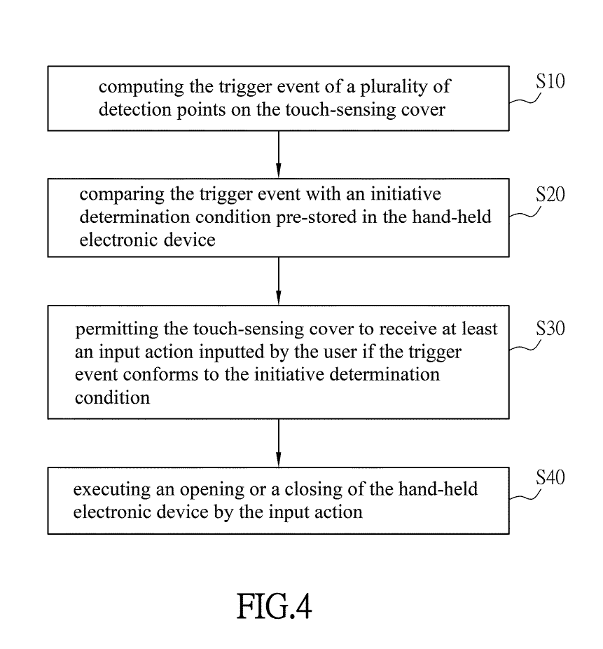

FIG. 4 is a schematic flowchart of the computer-executed method of an embodiment of the invention. As shown in FIG. 4, the computer-executed method of this embodiment executes, on the hand-held electronic device 1, the following steps of: computing the trigger event of a plurality of detection points on the touch-sensing cover (step S10); comparing the trigger event with an initiative determination condition pre-stored in the hand-held electronic device (step S20); permitting the touch-sensing cover to receive at least one input action inputted by the user if the trigger event conforms to the initiative determination condition (step S30); and executing the opening or closing of the hand-held electronic device by the input action (step S40).

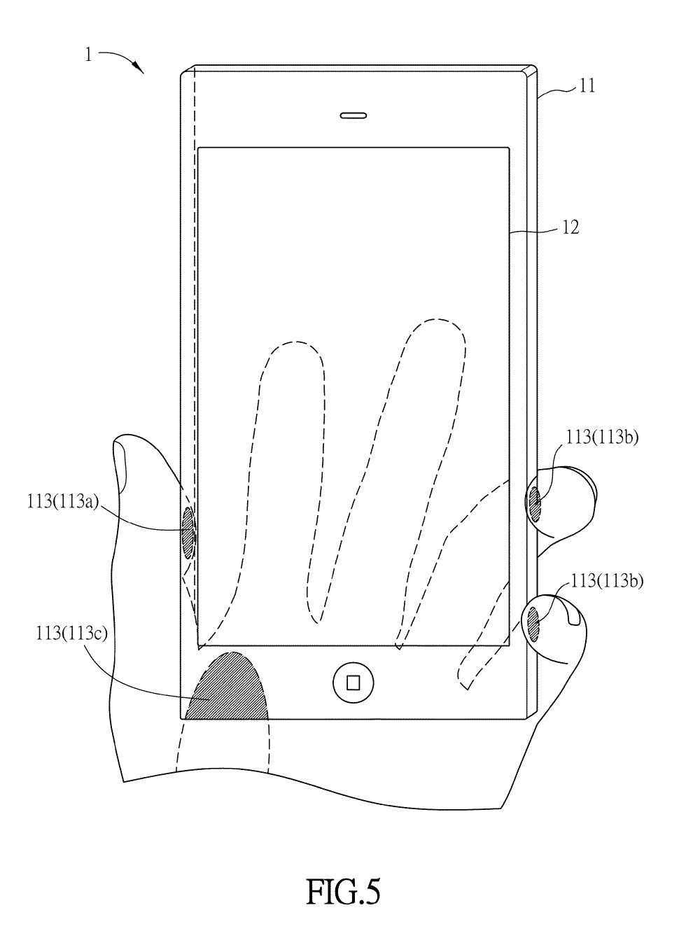

Refer to FIGS. 2 and 5, and FIG. 5 is a schematic diagram showing that the detection point of the touch-sensing cover in FIG. 1 is triggered. In physical, when the user operates the hand-held electronic device 1, the user can preset the holding usage when operating the setting interface, accordingly, the control unit 13 can analyze the trigger event of the detection point triggered by the user when operating the setting interface. The trigger event can be defined as the initiative determination condition and stored in the storage unit 14. The trigger event includes the trigger quantity distribution, trigger time, trigger frequency, trigger morphology (which can refer to trigger appearance) or trigger location (which can refer to trigger position). As to the trigger event of the trigger quantity distribution, trigger morphology or trigger location for example, when the user holds the hand-held electronic device 1, the control unit 13 can analyze the detection point which is triggered by the user's holding and define the region where the number of the adjacent triggered detection points P is larger than a predetermined range as a trigger area 113. As shown in FIG. 5, in this embodiment, one of the sidewalls of the touch-sensing cover 11 has a trigger area 113a, the other sidewall has two trigger areas 113b, and the surface of the touch-sensing cover 11 opposite the panel 12 has a trigger area 113c. Furthermore, in this embodiment, the trigger quantity distribution and the trigger location indicate the quantity and the location of each trigger area, respectively, and the trigger morphology indicates the shape or appearance of each trigger area 113, i.e. the shapes or appearance of the trigger areas 113a, 113b and 113c. Moreover, the trigger frequency can indicate the click frequency at a certain location, and the trigger time indicates that the holding time exceeds a certain time or related to the user's personal habit.

Accordingly, after the user completes the setting through the setting interface and the storage unit 14 stores the initiative determination condition, the control unit 13 can compare other trigger events with the initiative determination condition. In physical, if other trigger events occur, the control unit 13 will compute the trigger quantity distribution, trigger time, trigger frequency, trigger morphology or trigger location of the detection point on the touch-sensing cover 11 triggered by other trigger events, and also compare the computed result with the initiative determination condition pre-stored in the hand-held electronic device 1. In other embodiments, in order to enhance the security of the hand-held electronic device 1, the control unit 13 will compute the trigger event on the touch-sensing cover 11 at the predetermined time intervals. In other words, the control unit 13 will compute the trigger quantity distribution, trigger time, trigger frequency, trigger morphology or trigger location of the detection point triggered at different times.

If the trigger event conforms to the initiative determination condition, the touch-sensing structure 112 will be permitted to receive at least one input action inputted by the user. In other words, on the premise that the trigger quantity distribution, trigger time, trigger frequency, trigger morphology or trigger location conforms to the initiative determination condition, the control unit 13 just can execute other actions to permit the touch-sensing structure 112 to receive the user's input action, and then the hand-held electronic device 1 can execute the operation by the input action. To be noted, the input action in this embodiment is executed by one hand, and the operation of this embodiment especially comprises the opening or closing of the hand-held electronic device 1, such as turning on or off the device, starting or ending the application program or ending the conversation, which will be further illustrated later. Therefore, when other users want to hold and operate the hand-held electronic device 1, the operation will be forbidden because the trigger quantity distribution, trigger time, trigger frequency, trigger morphology or trigger location doesn't conform to the initiative determination condition set by the original user, and the security of the hand-held electronic device 1 can be enhanced thereby.

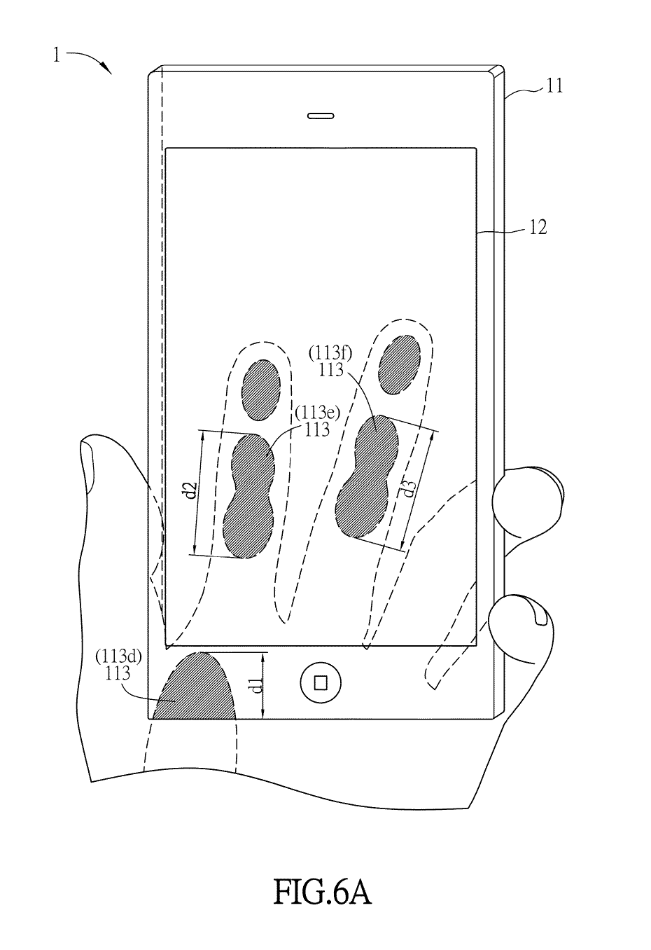

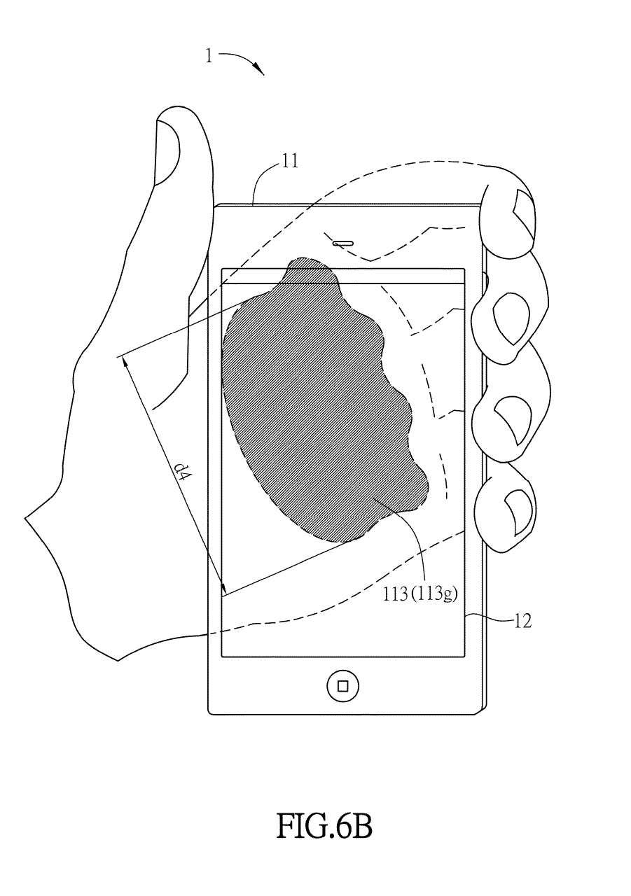

FIGS. 6A and 6B are other schematic diagrams showing that the detection point of the touch-sensing cover of FIG. 1 is triggered. As shown in FIG. 6A, the illustration here is that if the touch morphology exhibits multiple area contacts, it will be directly determined not to conform to the initiative determination condition. Herein, multiple area contacts denote two or more area contacts. In this embodiment, the “area contact” denotes that the diameter of a single trigger area caused by the user contacting the touch-sensing cover 11 or the longest distance from an edge of the contact to the other edge of the contact is 7 mm or more. As shown in FIG. 6A, for example, because the trigger areas 113d, 113e and 113f are not circles, the trigger event will be directly determined not to conform to the initiative determination condition when the longest distance d1, d2, d3 from an edge of the contact to the other edge of the contact of each of the trigger areas 113d, 113e and 113f is larger than 7 mm. The case of the multiple area contacts is easily caused when the user just purely holds the hand-held electronic device 1 instead of touching or operating the hand-held electronic device 1, so the trigger event caused thereby is directly determined not to conform to the initiative determination condition. Moreover, as shown in FIG. 6B, if the trigger morphology of the trigger event exhibits a single area contact and occurs on the upper portion of the hand-held electronic device 1, it is also determined not to conform to the initiative determination condition. The above configuration is based on that if the user normally holds the hand-held electronic device 1 and executes the touch operation on the touch-sensing cover 11 by the finger, the user's palm may form the trigger area of the area contact at the lower portion of the hand-held electronic device 1 instead of forming the trigger area of the area contact at the upper portion. Besides, when the finger executing the touch operation on the upper portion contacts the touch-sensing cover 11 to form a trigger area, the diameter of the trigger area or the longest distance from an edge of the contact to the other edge of the contact is often not larger than 7 mm. Therefore, when the trigger area 113g shown in FIG. 6B is caused on the upper portion of the hand-held electronic device 1 and the longest distance d4 from an edge of the contact to the other edge of the contact is larger than 7 mm, it is quite possible that the user may clean the cover or purely hold the hand-held electronic device 1 instead of executing the touch operation. So, if the trigger morphology of the trigger event exhibits a single area contact and occurs on the upper portion of the hand-held electronic device 1, it is also determined not to conform to the initiative determination condition. Herein, the upper portion or the lower portion can be defined according to the center of the cover or the center of the touch-sensing structure and in the situation of the user operating the hand-held electronic device 1. The portion above the center is the upper portion while the portion below the center is the lower portion.

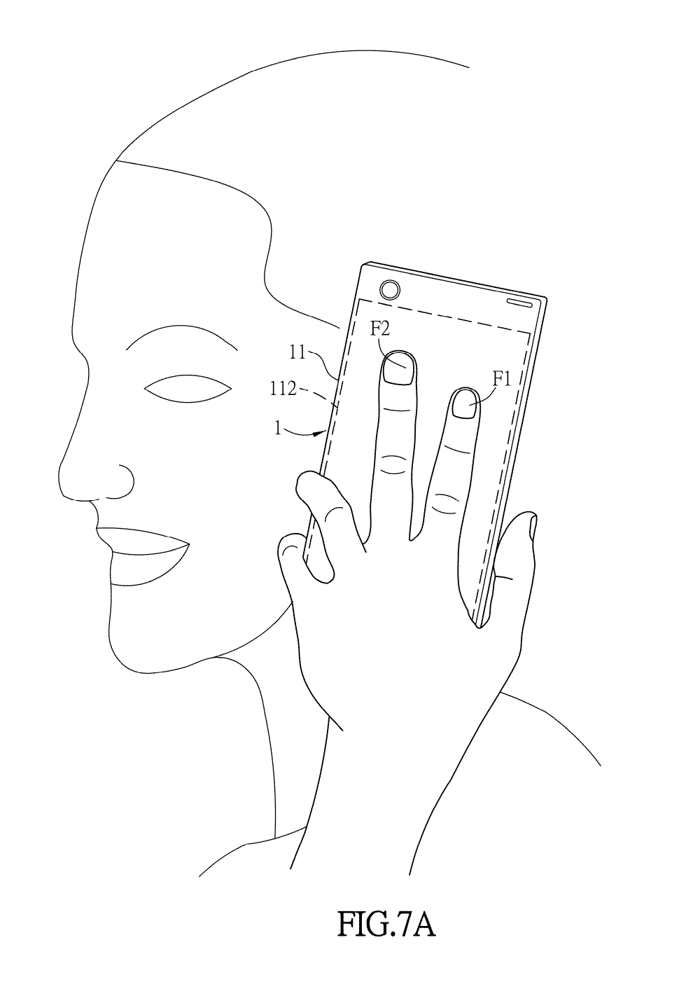

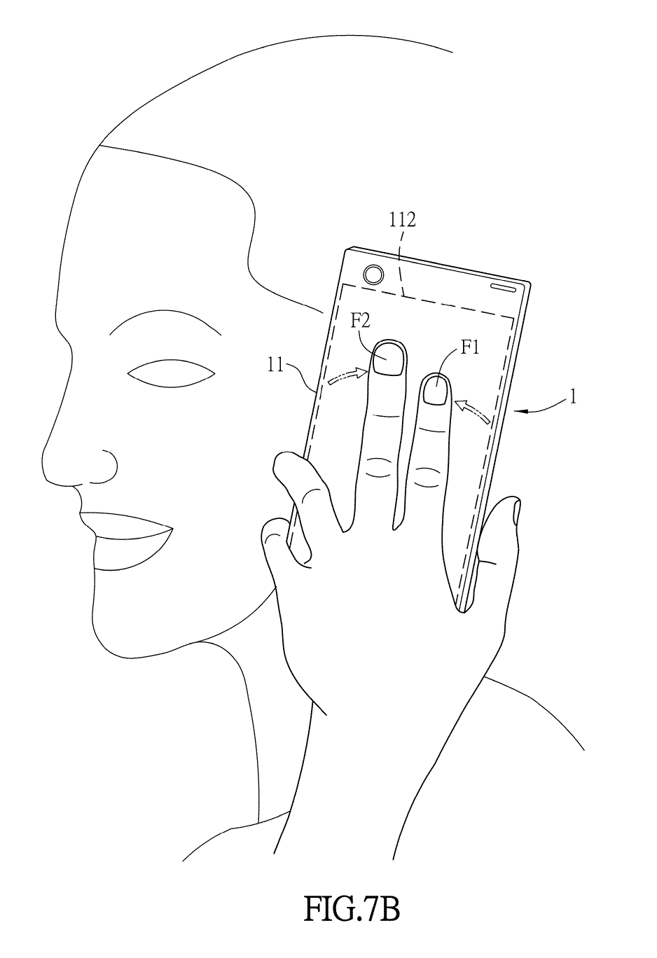

The illustration about the opening and closing is given as below. FIGS. 7A and 7B are schematic diagrams showing that the user operates the hand-held electronic device of FIG. 1 according to an embodiment of the invention. In this embodiment, the hand-held electronic device 1 is in a conversation state. As shown in FIG. 7A, when the hand-held electronic device 1 in the conversation state, the connected conversation will be terminated if the user uses two fingers (especially the forefinger F1 and the middle finger F2) to contact the touch-sensing cover 11 at the same time, and that means the conversation will be terminated forcibly. As shown in FIG. 7B where the hand-held electronic device 1 is also in the conversation state, if the user makes a pinch slide on the touch-sensing cover 11 by two fingers (especially the forefinger F1 and the middle finger F2), the conversation will also be forcibly terminated.

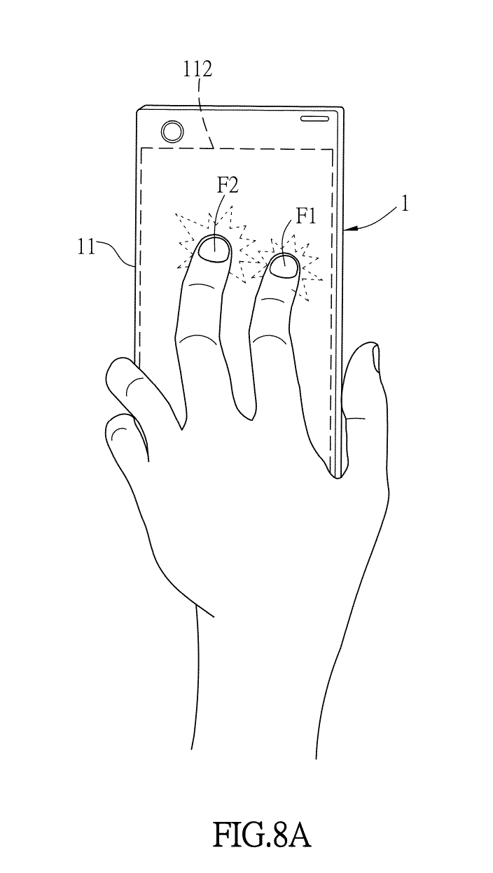

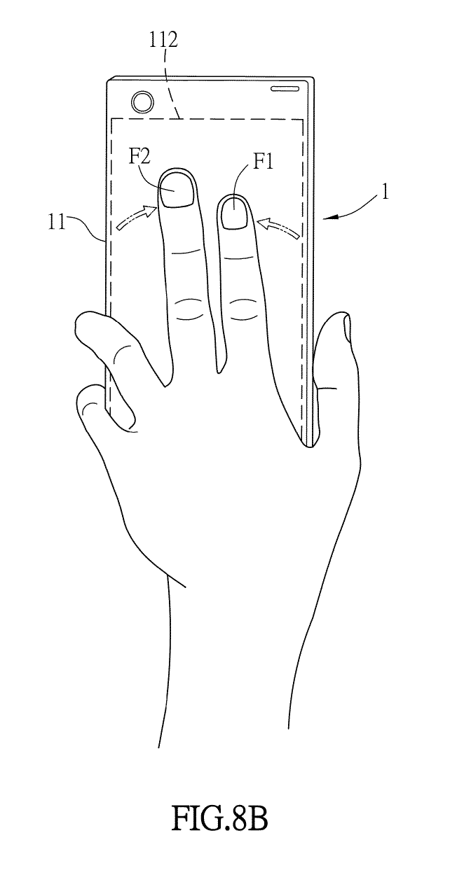

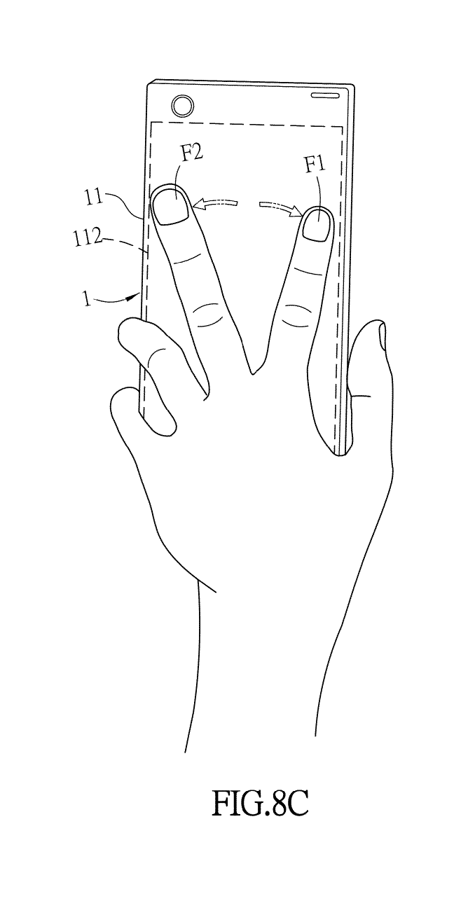

FIGS. 8A to 8C are schematic diagrams showing that the user operates the hand-held electronic device of FIG. 1 according to other embodiments of the invention. As shown in FIG. 8A, in this embodiment where the hand-held electronic device 1 is in a non-conversation state, if the user uses two fingers (especially the forefinger F1 and the middle finger F2) to contact the touch-sensing cover 11 at the same time, the different openings or closings will be generated according to the state of the hand-held electronic device 1, which will be illustrated as below with different situations.

If the hand-held electronic device 1 is opening a certain application (APP), the user can use two fingers to contact the touch-sensing cover 11 at the same time to forcibly terminate the application.

If the hand-held electronic device 1 is in the non-conversation state and also in the shutdown state, the user can use two fingers to contact the touch-sensing cover 11 at the same time to turn on the hand-held electronic device 1, which means the hand-held electronic device 1 will execute a boot program.

If the hand-held electronic device 1 doesn't start any application program and is in a power-on state, the user can use two fingers to contact the touch-sensing cover 11 at the same time to forcibly shut down the hand-held electronic device 1 or start a certain application program, which means the hand-held electronic device 1 will execute a shutdown program or start the certain application program. In this embodiment, the certain application program can be preset by the user. For example, the user can set the commonly-used or favorite application program as the predetermined application program, and the predetermined application program will be started when the user uses two fingers to contact the touch-sensing cover 11 at the same time. The user also can preset that the hand-held electronic device 1 will execute the shutdown program or start the application program.

As shown in FIG. 8B where the hand-held electronic device 1 is also in the non-conversation state, if the user uses two fingers (especially the forefinger F1 and the middle finger F2) to do a pinch slide on the touch-sensing cover 11, the different openings or closings will be generated according to the state of the hand-held electronic device 1, which will be illustrated as below with different situations.

When the hand-held electronic device 1 is opening a certain application program, the user can use two fingers to do a pinch slide on the touch-sensing cover 11 to forcibly terminate the application program.

If the hand-held electronic device 1 doesn't start any application program and is in the power-on state, the user can use two fingers to do a pinch slide on the touch-sensing cover 11 to forcibly shut down the hand-held electronic device 1, which means the hand-held electronic device 1 will execute the shutdown program.

As shown in FIG. 8C where the hand-held electronic device 1 is also in the non-conversation state, if the user uses two fingers (especially the forefinger F1 and the middle finger F2) to do a stretch slide on the touch-sensing cover 11, the different openings or closings will be generated according to the state of the hand-held electronic device 1, which will be illustrated as below with different situations.

If the hand-held electronic device 1 doesn't start any application program, the user can use two fingers to do a stretch slide on the touch-sensing cover 11 to make the hand-held electronic device 1 start a certain application program. Likewise, the certain application program can be preset by the user. For example, the user can set the commonly-used or favorite application program as the predetermined application program.

If the hand-held electronic device 1 is in the non-conversation state and also in the shutdown state, the user can use two fingers to do a stretch slide on the touch-sensing cover 11 to turn on the hand-held electronic device 1, which means the hand-held electronic device 1 will execute the boot program.

Accordingly, the user can directly execute the opening or closing of the hand-held electronic device 1 (such as turning on or off the device, starting or ending the application program or ending the conversation) while being in the same holding posture, instead of moving the finger to the position of the physical key or using another hand to contact the touch display panel for the control as in the conventional art.

Moreover, a touch-sensing cover of the hand-held electronic device is also disclosed. The hand-held electronic device comprises a panel, a touch-sensing cover and a control unit. The touch-sensing cover comprises a cover and a touch-sensing structure. The cover is disposed on the side of the hand-held electronic device opposite the panel. Partial or total area of the touch-sensing structure is disposed on the cover. The touch-sensing structure is coupled with the control unit. The touch-sensing structure comprises a plurality of detection points which can be triggered. The control unit computes the trigger event of the detection points and compares the trigger event with the initiative determination condition pre-stored in the hand-held electronic device. If the trigger event conforms to the initiative determination condition, the touch-sensing structure is permitted to receive at least one input action inputted by the user and the opening or closing of the hand-held electronic device can be executed by the input action. The structure and connection relation of other components of the touch-sensing cover can be comprehended by referring to the above description, so the related illustrations are omitted here for conciseness.

In some embodiments, the hand-held electronic device 1 can further comprise a near field communication unit, which comprises a near field communication chip and an antenna. The near field communication chip is electrically connected with the control unit 13, and the antenna can be disposed on the cover 111 or the touch-sensing structure 112 for example, but this invention is not limited thereto. When the user wants to use the hand-held electronic device 1 to communicate with another electronic device through the near field communication (NFC), the hand-held electronic device 1 can be made closer to another electronic device having the near field communication function to receive data from or transmit data to the another electronic device through the antenna and the near field communication chip.

To be noted, the features mentioned in the above embodiments can be implemented separately or together.

Summarily, in the hand-held electronic device, touch-sensing cover and computer-executed method of the invention, the user can execute the touch operation on the touch-sensing cover of the hand-held electronic device, so the finger of the user won't shade the user's view or the software object displayed on the panel, and also the touch for opening the link in the high information density image won't be erroneously executed. Besides, since the user operates the electronic device through the touch-sensing cover, the panel scratch situation can be reduced. Furthermore, because the user can execute the touch operation on the touch-sensing cover, the user can use multiple fingers such as the forefinger and middle finger to operate the electronic device while using the same hand holding the device. In comparison with the conventional art where the user just can use the thumb to execute the operation while using the same hand holding the device, this invention can provide more efficiency and convenience for the operation and can realize a better user experience.

Furthermore, when using the hand-held electronic device under the strong sunlight, the user can hold the hand-held electronic device by one hand and also adopt the touch-sensing cover to block the sunlight or a light source. Since the content displayed on the panel is shielded from the sunlight by the touch-sensing cover, the sunlight readability of the display panel can be enhanced, which is achieved without using the novel OLED or electronic paper display panel technology.

Besides, on the premise that the trigger quantity distribution, trigger time, trigger frequency, trigger morphology or trigger location conforms to the initiative determination condition, the touch-sensing cover just can be permitted to receive at least one input action inputted by the user for executing the opening or closing of the hand-held electronic device, such as turning on or off the device, starting or ending the application program, or ending the conversation. Therefore, when other users want to operate the hand-held electronic device, the operation of the above-mentioned opening or closing will be forbidden because the trigger quantity distribution, trigger time, trigger frequency, trigger morphology or trigger location doesn't conform to the initiative determination condition set by the original user, therefore, the security of the hand-held electronic device can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A hand-held electronic device, comprising:
a touch-sensing cover comprising a cover and a touch-sensing structure, wherein partial or total area of the touch-sensing structure is disposed on the cover and the touch-sensing structure comprises a plurality of detection points;
a panel; and
a control unit electrically connected with the touch-sensing cover and the panel and executing following steps of:
computing a trigger event of the detection points;
comparing the trigger event with an initiative determination condition pre-stored in the hand-held electronic device;
permitting the touch-sensing structure to receive at least an input action inputted by a user if the trigger event conforms to the initiative determination condition; and
executing an opening or a closing of the hand-held electronic device by the input action.

2. The hand-held electronic device as recited in claim 1, wherein when the hand-held electronic device is in a conversation state, the closing to end the conversation is executed by the input action if the input action is a simultaneous contact or a pinch slide of two fingers on the touch-sensing cover.

3. The hand-held electronic device as recited in claim 1, wherein when the hand-held electronic device is in a non-conversation state and opening an application program, the closing to close the application program is executed by to the input action if the input action is a simultaneous contact or a pinch slide of two fingers on the touch-sensing cover.

4. The hand-held electronic device as recited in claim 1, wherein when the hand-held electronic device is in a non-conversation state and no application program opened, the closing to turn off the hand-held electronic device is executed by the input action if the input action is a simultaneous contact or a pinch slide of two fingers on the touch-sensing cover.

5. The hand-held electronic device as recited in claim 1, wherein when the hand-held electronic device is in a non-conversation state and no application program opened, the opening to open an application program of the hand-held electronic device is executed by the input action if the input action is a simultaneous contact or a stretch slide of two fingers on the touch-sensing cover.

6. The hand-held electronic device as recited in claim 1, wherein when the hand-held electronic device is in a shutdown state, the opening to turn on the hand-held electronic device is executed by the input action if the input action is a simultaneous contact or a stretch slide of two fingers on the touch-sensing cover.

7. The hand-held electronic device as recited in claim 1, wherein the touch-sensing structure is a single-layer structure of a double-layer structure.

8. The hand-held electronic device as recited in claim 1, wherein a wiring connecting to the touch-sensing structure is gathered to a single side for wiring outlet.

9. The hand-held electronic device as recited in claim 1, wherein a width of the touch-sensing structure is less than that of the cover by 5%˜10%.

10. The hand-held electronic device as recited in claim 1, wherein the area of the touch-sensing structure has a ratio relationship to the area of the panel, and the control unit converts an input position of the touch-sensing structure to a display position of the panel according to the ratio relationship.

11. The hand-held electronic device as recited in claim 1, wherein the user operates the hand-held electronic device by one hand, and the touch-sensing cover faces a light source or the back of the panel faces the light source.

12. The hand-held electronic device as recited in claim 1, wherein the touch-sensing structure is capable of a wireless power transmission.

13. The hand-held electronic device as recited in claim 1, wherein the touch-sensing cover further comprises a near field communication unit, which comprises a near field communication chip and an antenna, the near field communication chip is electrically connected with the control unit, and the antenna is disposed on the cover or the touch-sensing structure.

14. A computer-executed method applied to a hand-held electronic device comprising a touch-sensing cover, a panel and a control unit, the method executing, on the hand-held electronic device, following steps of:
computing a trigger event of a plurality of detection points on the touch-sensing cover;
comparing the trigger event with an initiative determination condition pre-stored in the hand-held electronic device;
permitting the touch-sensing cover to receive at least an input action inputted by a user if the trigger event conforms to the initiative determination condition; and
executing an opening or closing of the hand-held electronic device by the input action.

15. The computer-executed method as recited in claim 14, wherein when the hand-held electronic device is in a conversation state, the closing to end the conversation is executed by the input action if the input action is a simultaneous contact or a pinch slide of two fingers on the touch-sensing cover.

16. The computer-executed method as recited in claim 14, wherein when the hand-held electronic device is in a non-conversation state and opening an application program, the closing to close the application program is executed by the input action if the input action is a simultaneous contact or a pinch slide of two fingers on the touch-sensing cover.

17. The computer-executed method as recited in claim 14, wherein when the hand-held electronic device is in a non-conversation state and no application program opened, the closing to turn off the hand-held electronic device is executed by the input action if the input action is a simultaneous contact or a pinch slide of two fingers on the touch-sensing cover.

18. The computer-executed method as recited in claim 14, wherein when the hand-held electronic device is in a non-conversation state and no application program opened, the opening to open an application program of the hand-held electronic device is executed by the input action if the input action is a simultaneous contact or a stretch slide of two fingers on the touch-sensing cover.

19. The computer-executed method as recited in claim 14, wherein when the hand-held electronic device is in a shutdown state, the opening to turn on the hand-held electronic device is executed by the input action if the input action is a simultaneous contact or a stretch slide of two fingers on the touch-sensing cover.

20. A touch-sensing cover of a hand-held electronic device comprising the touch-sensing cover, a panel and a control unit, the touch-sensing cover comprising:
a cover; and
a touch-sensing structure, wherein partial or total area of the touch-sensing structure is disposed on the cover and the touch-sensing structure comprises a plurality of detection points;
wherein the control unit computes a trigger event of the detection points and compares the trigger event with an initiative determination condition pre-stored in the hand-held electronic device, if the trigger event conforms to the initiative determination condition, the touch-sensing structure is permitted to receive at least an input action inputted by a user, and an opening or a closing of the hand-held electronic device is executed by the input action.
